(19) United States
(12) Patent Application Publication
(10) Pub. No.: US 2024/0335685 A1
(43) Pub. Date: Oct. 10, 2024

(54) Rapid Deployment Harness Using Electroviscous Fluids

(71) Applicant: Bradley Zang, Jacksonville, FL (US)

(72) Inventor: Bradley Zang, Jacksonville, FL (US)

(21) Appl. No.: 18/132,614

(22) Filed: Apr. 10, 2023

(51) Int. Cl. A62B 35/00

(52) U.S. Cl. CPC A62B 35/0025

(57) ABSTRACT

A belt will be worn by the individual. Attached to this belt will be a plurality of rolled up legs and gas canisters. Electro-viscous fluid is contained in the harness that will activate the gas canisters; the advantage of using electro-viscous fluid is that it will cause a rapid inflation of the legs with minimal power. On the front of the belt will be an activation device that will send a small electrical charge to engage the gas-powered canisters to quickly inflate the plurality of legs and prevent the person from falling.

### PRIORITY claim

This is a continuation in part of a prior filed application and the applicant is claiming priority based on the prior filed application with the Ser. No. 17/090,504 with a filing date of Nov. 5, 2020.

### BACKGROUND OF THE INVENTION

### A. Field of the Invention

This is a device that we use for people who are a fall risk. It will consist of a harness which is worn by an individual in the event the person begins to fall or is in danger of falling. It will rapidly deploy a series of support legs that will prevent the person from falling. While the specific number of legs is not mentioned, it will be enough to support an adult and it is likely to be three or four.

Electro-viscous fluids are used after a small jolt of power ignites and deploys the leg.

### B. Prior Art

There are many other prior art references to devices that prevent individuals from falling and also discuss the use of electro-viscous fluids. A representative example of that discusses electro-viscous fluids can be found at Goossens, U.S. U.S. Pat. No. 4,668,417. This discusses in general the purpose of Electro-viscous fluids which is very useful when transmitting powerful forces by means of electronic output such as that used in valves and shock absorbers.

Another representative example in the prior art can be found at Inoue, U.S. Pat. No. 5,607,617. This discusses that electro-viscous fluids are stable at both ambient temperatures and elevated temperatures and can be activated using alternating or direct current.

In the current application, it is anticipated that this will be activated using direct current only through a less likely battery system.

For this device they discuss rapid inflation devices including, among others, Gonzaga, U.S. Pat. No. 7,188,518. This is a rapid-in-place device having a supply of pressurized fluid where the holder assembly activates and deactivates the pressurized fluid feeding on the operator's control, the sensors the sensors and the nozzle holder assembly.

The object is to rapidly deploy a device or inflate a device. This does not use electro-viscous fluid specifically when used with prior pressurized fluid

Another example in the prior art includes Thomas, U.S. Pat. No. 7,862,082 which is an airbag inflation vessel. When the device is rapidly inflated, it should do it in a totally uniform fashion and a baffle such as discussed in Thomas has been noted in the prior art.

In this case, this application uses a series of gas conduits. There is also a series of smaller gas conduits as well as gas pockets.

Another rapid inflation device can be found at Lin, U.S. Publication 2009/0188570. The instructions in this particular device is substantially different from the current application. Other examples include Sabliere, U.S. Publication 2010/0198249 and Henry, U.S. Publication 2017/0304660.

### BRIEF SUMMARY OF THE INVENTION

This device will consist of a harness which is worn by the individual. The harness may or may not have suspenders but, as drawn, suspenders are anticipated for additional support.

A belt which is connected to the suspenders will also be used. The belt on the belt structure will have a plurality of rolled-up legs which can be deployed. A plurality of gas canisters which are approximate to the rolled-up legs are also provided.

In operation, a battery or a small DC power source will activate the electro-viscous fluids, in turn, will cause the rolled-up legs to inflate rapidly by activating the gas canisters. The electro-viscous fluids are part of the material of each of the legs.

Sensors are provided to ensure that the leg will stop inflating when the sensor strikes the ground. The sensors, however, are not needed for the device to work but are incorporated as a safety device that is implemented by the use of electro-viscous fluids. For example, if the sensor that is on the bottom of the leg does not touch the ground, the current would stop and the leg would not fully deploy and become soft and unable to support the weight of the person. This is needed to prevent further injury to the person risking falling on an assistive device such as a cane.

The device should deploy sufficiently rapidly to prevent a fall of an individual and at least stop the individual from falling completely to the ground.

Within each of the legs will be a series of gas conduits. One will be a central gas conduit already aligned which will be branch off into a plurality of small gas conduits that will have two gas pockets at the end in the center of the structure to provide support.

### BRIEF DESCRIPTION OF THE DRAWINGS

FIG. 1 is an isometric view of the device.

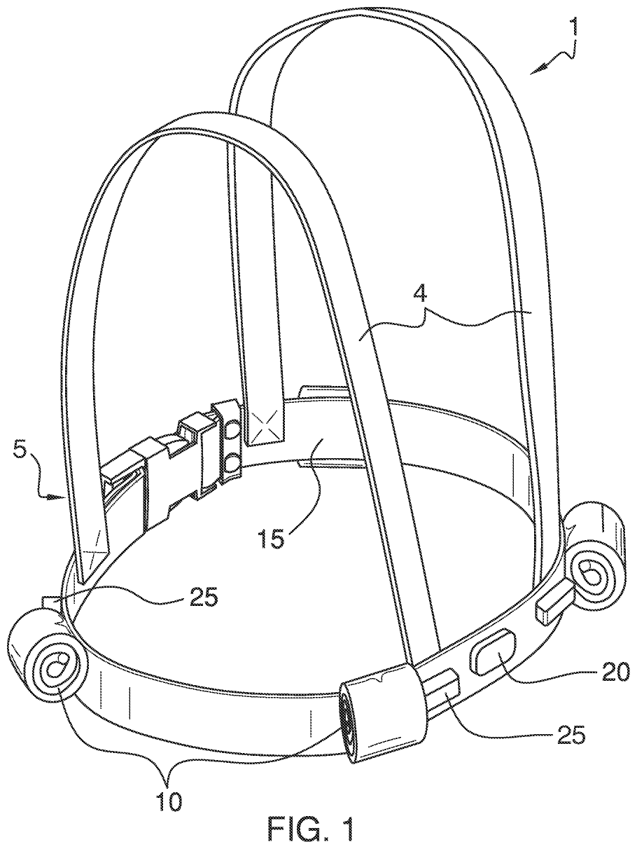

FIG. 2 is a front view of the device.

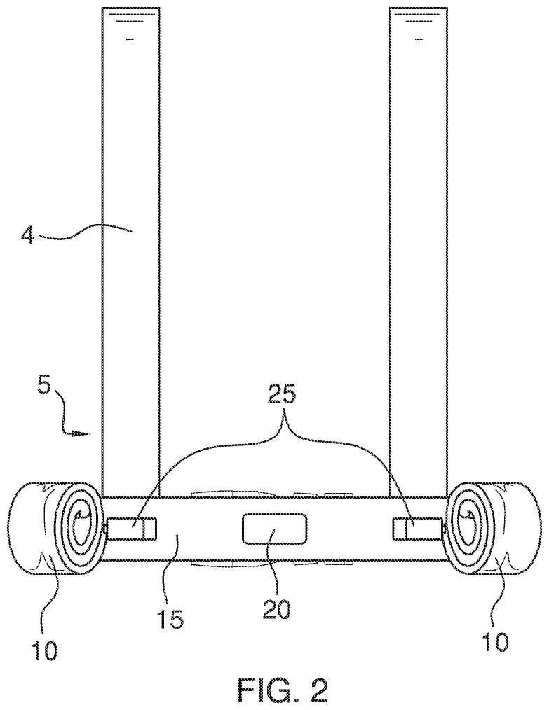

FIG. 3 is a back view of the device.

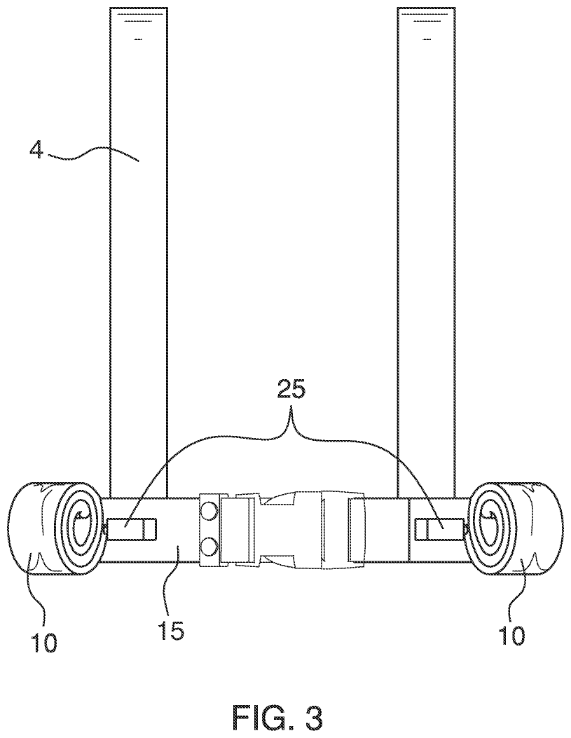

FIG. 4 is an in-use front view.

FIG. 5 is an in-use back view.

FIG. 6 is a detailed view of the rolled-up leg.

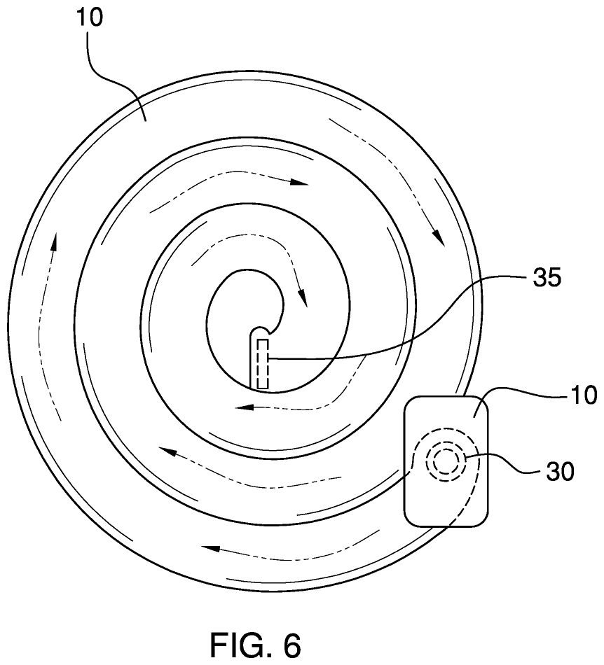

FIG. 7 is a cross-sectional view according to Line 7-7 of FIG. 4.

### NUMBERING DESCRIPTION

1-Device
4-Suspenders
5-Harness
10-Rolled up leg
12-Deployed leg
15-Belt
20-Power Source
25-Gas Canister
30-Valve
35-Sensor
40-Gas Conduit
45-Small Gas Conduit Passages
50-Gas Pocket

### DETAILED DESCRIPTION OF THE EMBODIMENTS

This safety device 1 will consist of a belt 15 with a buckle as well as suspenders 4 that form a part of the harness 5.

Along the exterior of the belt mechanism will be a plurality of rolled-up legs 10 which are attached to the belt. A buckle is placed on the belt 15 to remove the device when needed.

Adjacent and proximate to each of the rolled-up legs 10 will be a plurality of gas canisters 25. Each of the gas canisters 25 will activate a valve 30 that will allow the gas from the gas canister 25 to rapidly inflate the plurality of rolled up legs 10 that are positioned on the belt 15.

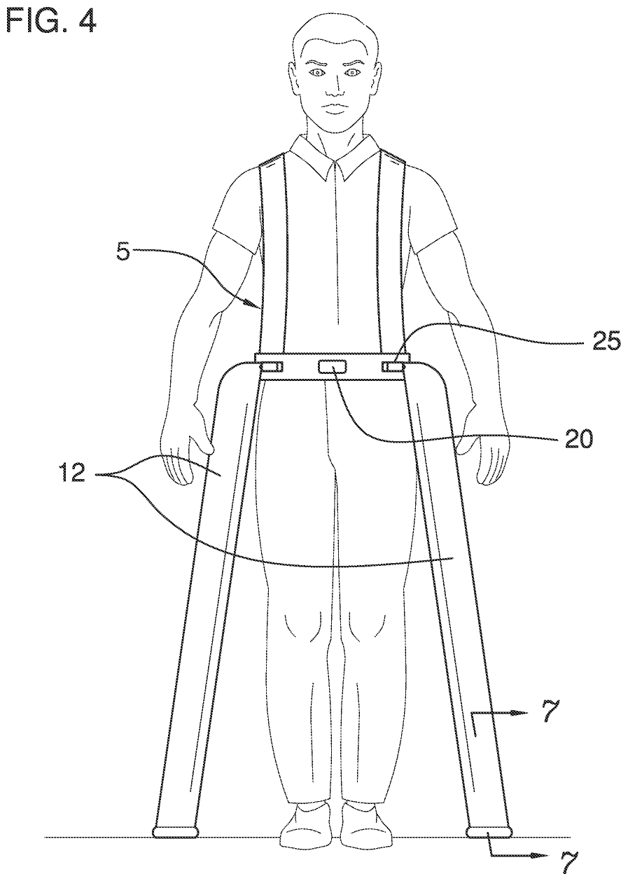

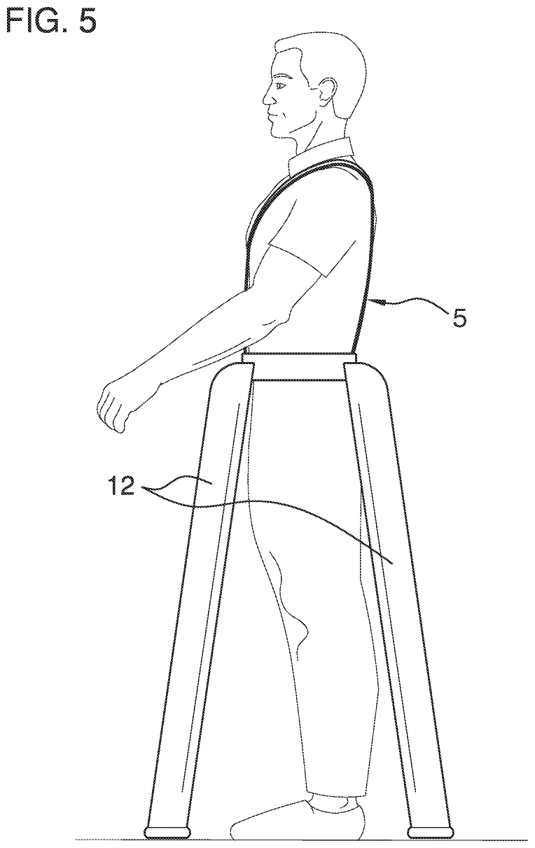

When the device is deployed, the plurality of rolled up legs will become a plurality of deployed legs 12 that will prevent the person from falling such as depicted in FIG. 4. A sensor 35 on the bottom of each of the legs will detect when the leg is fully deployed and the sensor 35 will provide a base for support for the leg when the leg is fully deployed such as depicted in FIGS. 4 and 5.

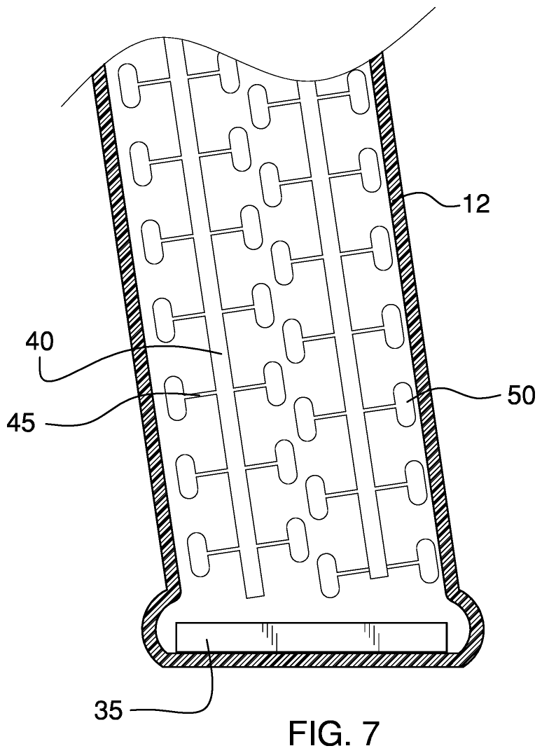

A cross-sectional view of the legs such as depicted in FIG. 7 show a gas conduit 40 that will allow the gas to flow through the conduit and travel through a plurality of small gas conduit passages 45 that lead to a plurality of gas pockets 50 which are located near the outside of the surface of the deployed leg 12.

A small DC power source 20 such as a battery will be used to activate the electro-viscous fluid, which is contained within the material of the leg. An electrical current from the power source will cause the gas canister 25 to deploy and cause a valve 30 which is connected to the gas canister 25 to open. The deployment of the gas canister 25 and the opening of the valve 30 will allow gas to travel through the gas conduit 40, and into the gas pockets 50 through the small gas conduit passages 45 to rapidly inflate each of the individual deployed legs 12.

After the leg is extended, a second current will be applied to the electro-viscous fluid, which is embedded in the leg material to provide rigidity.

Once the sensor 35 strikes the ground such as depicted in FIG. 7, the deployed leg should be able to support the weight of a person.

The electro-viscous fluids will be made as part of the construction of the material for the leg and the combination of the release of gas from the gas canister and the activation of the electro-viscous fluids within the leg material will cause a rapid inflation of the rolled-up legs with the needed rigidity to support a human person. There are multiple types of electro-viscous fluids that are available and no one type is being claimed. All electro-viscous fluids share a common property to cause a chain reaction quickly with very little power input. Regardless of the type of electro-viscous fluid that is being used, the electro-viscous fluid should not be harmful to humans.

While the embodiments of the invention have been disclosed, certain modifications may be made by those skilled in the art to modify the invention without departing from the spirit of the 3 invention.

The inventor claims:

1. A safety device using electro-viscous fluids which is comprised of:
a harness;
wherein the harness is of a predetermined shape;
a buckle;
said buckle is integral to the harness;
a plurality of rolled up legs;
wherein the plurality of rolled up legs are attached to the harness;
said each of the plurality of legs are rolled up when the device has not been activated;
a plurality of sensors;
wherein the plurality of sensors are at the first end of a plurality of deployed legs;
a plurality of gas canisters;
wherein the plurality of gas canisters are placed adjacent to the plurality of the rolled-up legs on the harness;
a plurality of valves;
wherein the plurality of valves allow the flow of gas through the plurality of rolled up legs;
a gas conduit;
wherein the gas conduit is embedded in each of the rolled-up legs;
wherein the plurality of gas conduits extend the length of the deployed leg;
wherein the plurality of gas conduits extends the length of the leg;
a plurality of small gas conduit passages;
wherein the plurality of small gas conduit passages extend outward from the gas conduits;
a plurality of gas pockets;
wherein the plurality of gas pockets are attached to the plurality of small gas conduits;
a power source;
wherein a power source is provided;
electro-viscous fluid;
wherein the power source activates the electro-viscous fluids;
said electro-viscous fluids are part of the leg material;
wherein the activation of the electro-viscous fluids cause the reaction to deploy each of the plurality of the gas canisters;
wherein the plurality of deployed legs touch the ground surface.
